(19) United States
(12) Patent Application Publication
(10) Pub. No.: US 2016/0207247 A1
(43) Pub. Date: Jul. 21, 2016

(54) DEVICE FOR BENDING TUBES BY THERMOFORMING

(71) Applicant: EATON LEONARD GROUP, Cologne (FR)

(72) Inventor: Philippe Jaubert, COLOGNE (FR)

(21) Appl. No.: 14/915,414

(22) PCT Filed: Aug. 28, 2014
(86) PCT No.: PCT/FR2014/000191

§ 371 Date: Feb. 29, 2016

(30) Foreign Application Priority Data
Sep. 4, 2013 (FR) 1302050

(51) Int. Cl. B29C 53/80; B29C 53/84; B29C 53/08

(52) U.S. Cl. CPC B29C 53/80; B29C 53/083; B29C 53/84; B29K 2077/00

(57) ABSTRACT

The invention relates to a bending device for producing bent plastic tubes by thermoforming, the tubes being inserted into the guide duct of forming templates (2a-2d). According to the invention, this bending de vice comprises at least three workstations (11-14) intended to take identical forming templates and comprising circulation means (18-20) designed to form a thermoforming fluids circulation circuit incorporating the tube borne by the forming template (2a-2d), a multi-articulated robotised system (28, 29) comprising a gripper (31) provided with a press member having a bearing surface able to apply to a tube a force that inserts said tube into the guide duct of the forming templates (2a-2d), and means for the relative displacement of the robotised system (28, 29) and workstations (11-14) which are designed so that said robotised system is positioned facing each of said workstations in succession.

### BACKGROUND OF THE INVENTION

The invention relates to a bending device for the production by thermoforming of bent tubes made of plastic material.

The tubes, so-called plastic tubing, made of plastic material, in particular of the thermoplastic polymer type, such as polyamide, used in particular in the automobile field and the aeronautical field, and having bent segments, are currently produced by thermoforming of tubes placed in shaping templates forming an open guide pipe that has the longitudinal profile of bent tubes.

Two thermoforming techniques are primarily used at present: a first technique consists of using heating furnaces into which are inserted the shaping templates, and a second technique consists of circulating, in the tubes positioned in the shaping templates, a heating fluid brought to a suitable temperature for achieving a brittle-ductile transition of the tubes.

One of the drawbacks of this second technique resides in the fact that its implementation requires multiple successive operations that lead to significant shaping cycle times and require consequent manual labor, which are reflected by high production costs.

### SUMMARY OF THE INVENTION

It is an object of this invention to remedy the drawbacks of this second thermoforming technique, and it has as a primary objective to provide a bending device designed to automate the majority of the bending operations and to raise the rate of production in a significant way.

Another objective of the invention is to provide a bending device that makes possible an automated mounting of components on the ends of the bent tubes.

For this purpose, an object of the invention is a bending device for the production by thermoforming of bent tubes made of plastic material, comprising shaping templates forming an open guide pipe that has the longitudinal profile of the bent tubes, and, according to the invention, this bending device comprises:
Centralized fluid supply for supplying a tube-heating fluid that is brought to a suitable temperature for achieving, by circulation of the fluid inside the tubes, a brittle-ductile transition of the tubes,
Centralized fluid supply for supplying at least one tube-cooling fluid by circulation of each fluid inside the tubes,
A shaping unit that comprises at least three work stations designed to be equipped with identical shaping templates, each of the work stations comprising:
   A support plate provided with a device for fixing and indexing the position of the shaping template,
   Suitable fluid circulation device for forming a fluid circulation circuit that incorporates the tube positioned on the shaping template and the suitable fluid circulation device comprising:
   A suitable distribution element for being connected to the centralized fluid supply and for making it possible to select the supply fluid of the circulation circuit,
   A feed pipe connected to the distribution element and provided with a free end that is equipped with a connector for airtight connection to the tube,
   A drain pipe provided with a free end equipped with a connector for airtight connection to the tube,
   And, for each of the connectors, a suitable support for being fixed on the support plate in the extension of the shaping template, on which the connector is mounted by an element for moving the connector between a position for airtight connection to the tube and a disconnected position of the tube,

A multi-articulated robotized system, comprising:
A hand for gripping a tube to be bent, provided with a press element that has a bearing surface that can apply to the tube a force for inserting the latter into the guide pipe of the shaping template,
Combined with a programmable unit of programmed guidance for controlling suitable motion of the hand of the robotized system so that the press element moves along a trajectory corresponding to the longitudinal profile of the guide pipe of the shaping template,
Relative displacement device of the robotized system and the shaping unit, adapted so that the robotized system is positioned opposite each of the work stations in succession,
And a central unit for managing the shaping unit and the robotized system that is programmed for controlling, after a manual initial stage for fixing the shaping templates and the supports of the connectors to the work stations, and for indexing the position of the shaping templates, shaping cycles that comprise, for each work station, the following stages:
   Insertion of the tube to be bent that is held in the hand of the robotized system in the guide pipe of the shaping template equipping the work station,
   Connection of the connectors to the tube by actuating the displacement elements of the connectors, and relative displacement of the shaping unit and of the robotized system designed to position the robotized system opposite another work station,
   Circulation of the fluid designed for achieving the brittle-ductile transition,
   Circulation of each cooling fluid,
   And disconnection of the connectors for the purpose of discharging the bent tube.

For each bent tube model, and therefore each shaping template model, such a bending device is therefore designed, after an initial manual stage of fixing shaping templates and supports of the connectors on the work stations and of indexing the position of the shaping templates, to carry out fully-automated shaping cycles during each of which, for each work station, a tube is charged on the shaping template positioned on the work station in succession, and then heated, cooled and finally brought into the discharging position.

In addition, it should be noted that the means for fixing the shaping templates can be of any standard type known in the art, with the indexing of the position of these shaping templates able to be of the material and/or software type.

In addition, such a bending device makes it possible to produce the bent tubes at high speed based on the time required for the longest operation (charging, heating, cooling).

According to an advantageous embodiment of the invention, the centralized heating-fluid supply comprise a water vapor production source.

The centralized fluid supply for supplying at least a cooling fluid advantageously comprises, according to the invention, a cold-water production source, and an air production source for drying tubes after the latter are cooled.

The bending device further advantageously comprises, according to the invention, a suitable automated plastic tube supply device for supplying the hand of the robotized system with plastic tube segments precut to a predetermined length.

In addition, these plastic tube supply device advantageously comprise according to the invention:
A packaging coil of the plastic tubing,
Means for unwinding the coil,
A sensor for measuring the length of the unwound tube,
And means for cutting tube segments of preselected lengths.

According to another advantageous embodiment of the invention, the displacement element of each connector is composed of a cylinder provided with a rod on which the connector is made integral, and a body fixed on the support.

Furthermore, so as to ensure perfect reproducibility of the shaping templates and consequently a perfect homogeneity of the bent tubes produced, each shaping template is advantageously provided with, according to the invention, a guide mechanism composed of specific guide elements comprising a channel with a cross-section mated to that of the tube, forming a guide pipe formed by a series of specific supports of the tube.

In addition, each of these guide elements advantageously comprises, according to the invention, a retentive-shaped channel having an opening for inserting and removing the tube provided with beveled longitudinal edges designed to facilitate inserting the tube into the retentive-shaped channel.

Furthermore, the robotized system of the bending device according to the invention advantageously has a hand that is articulated in such a way as to be able to be programmed so that the force for inserting the tube into the channel of each guide element is applied along an axis parallel to the plane of symmetry of the channel, thus facilitating inserting the tubes into the channels.

The press element of this robotized system advantageously is composed of, according to the invention, a wheel provided with a peripheral channel with a cross-section mated to that of the tube.

In addition, this press element is advantageously combined with a suitable elastic device for allowing the press element to travel in a direction that is parallel to the axis of the insertion force applied by the latter.

Furthermore, so as to prevent a possible longitudinal sliding of the tube inside the guide pipe, the bending device advantageously comprises, according to the invention, a retractable element for locking the end of the tube in the guide pipe of the shaping template, designed to be actuated during the insertion of a tube into a shaping template.

According to another advantageous embodiment of the invention, the gripping hand of the robotized system comprises motorized rollers placed and driven in rotation in such a way that the tube engages between the rollers and is entrained toward the press element in a direction of travel that is opposite to the direction of displacement of the gripping hand.

In addition, these motorized rollers are advantageously mounted on the gripping hand by a mechanism ensuring relative displacement of the rollers between a close driving position of the tube and a separated escapement position of the tube.

According to a first advantageous variant embodiment of the invention, the shaping unit comprises stationary work stations, with the relative displacement elements of the robotized system and the shaping unit being suitable for moving the robotized system in such a way as to bring it opposite each of the stationary work stations in succession.

In addition, according to this variant embodiment, the work stations are advantageously aligned one behind another, with the displacement elements of the robotized system being suitable for moving the latter along a straight trajectory.

According to a second advantageous variant embodiment of the invention, the shaping unit comprises suitable displacement elements of the work stations for bringing, in succession, the latter opposite a stationary position on which the robotized system is located.

In addition, according to this variant embodiment, the shaping unit advantageously comprises a circular table divided into circular sectors, each constituting a work station, with the displacement elements of the work stations being composed of drive elements in rotation of the circular table.

Furthermore, according to this second variant embodiment, the shaping unit, the drive elements in rotation of the circular table, and the centralized cooling-fluid supply are suitable for defining a so-called cooling position of the work stations, in which the two cooling fluids are delivered into the circulation circuit in succession.

The cumulative circulation time of the two cooling fluids actually proves to be on the order of the time required for achieving the brittle-ductile transition, and this arrangement makes it possible to achieve essentially similar heating and cooling times.

Furthermore, according to this second variant embodiment, the discharging operation can also be automated and, for this purpose, according to a first solution, the shaping unit and the drive elements in rotation of the circular table are advantageously suitable for defining a position of the work stations, called charging/discharging, and the robotized system advantageously comprises a second hand for gripping the bent tubes for the purpose of their discharging.

For the purpose of the automation of the discharging operation and according to another solution, the shaping unit and the drive elements in rotation of the circular table are advantageously suitable for defining:
A so-called charging position of the work stations, in which the work station is located opposite the robotized system,
A so-called discharging position of the work stations, in which the work station is located opposite a second robotized system provided with a suitable hand for ensuring the gripping and the discharging of the bent tube.

In addition, this second robotized system also advantageously comprises, according to the invention, a piece of equipment for mounting components on the ends of the bent tubes.

### BRIEF DESCRIPTION OF THE DRAWINGS

Other characteristics, objects, and advantages of the invention will emerge from the detailed description that follows with reference to the accompanying drawings that show two preferred embodiments of it by way of nonlimiting examples. In these drawings:

FIG. 1 is a diagrammatic elevation view of a first embodiment of a bending device in accordance with the invention,

FIG. 2 is a diagrammatic plan view of this first embodiment,

FIG. 3 is a diagrammatic top view of a work station of this first bending device embodiment, on which a shaping template is positioned,

FIG. 4 is a diagrammatic longitudinal view of the robotized system's hand shown during the insertion of a tube into a shaping template,

FIG. 5 is a transverse view of this hand during the insertion of a tube into a shaping template, and

FIG. 6 is a diagrammatic plan view of a second embodiment of a bending device in accordance with the invention.

### DETAILED DESCRIPTION OF THE INVENTION

The bending devices according to the invention shown by way of examples in the figures consist of bending devices for the production by thermoforming of bent tubes 1 made of plastic materials in particular of the thermoplastic polymer type, such as the polyamide, used in particular in the automobile field and the aeronautical field.

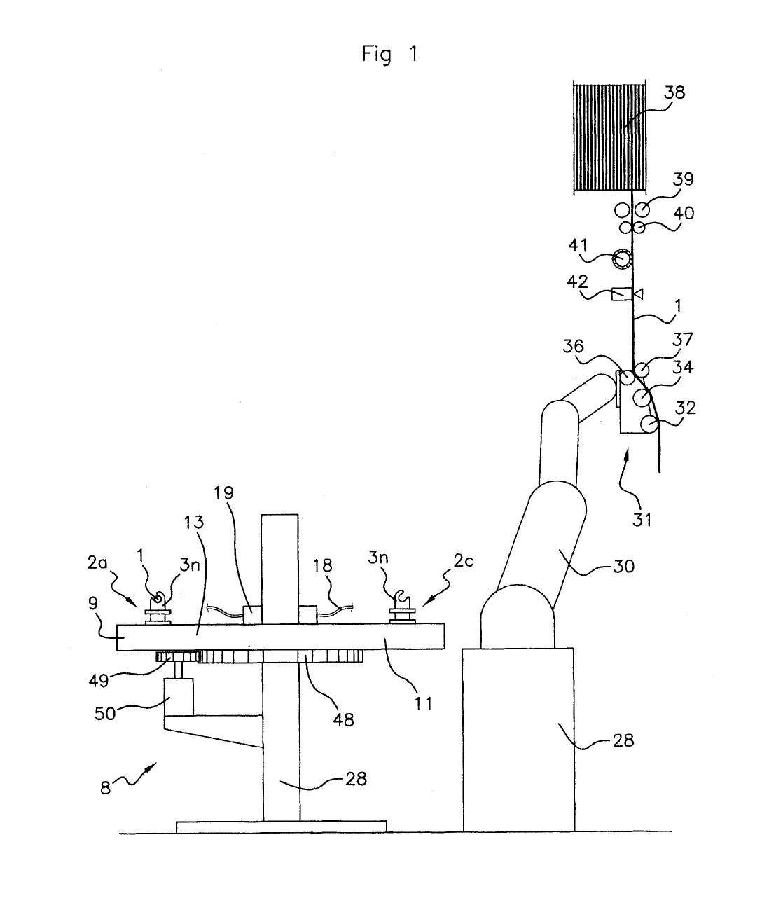

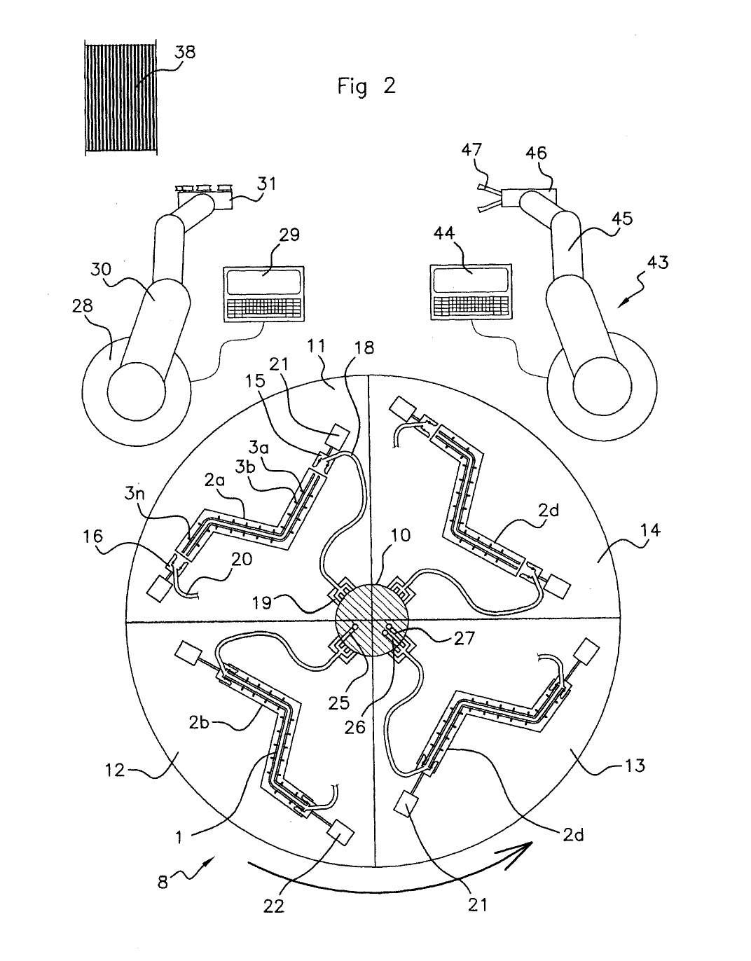

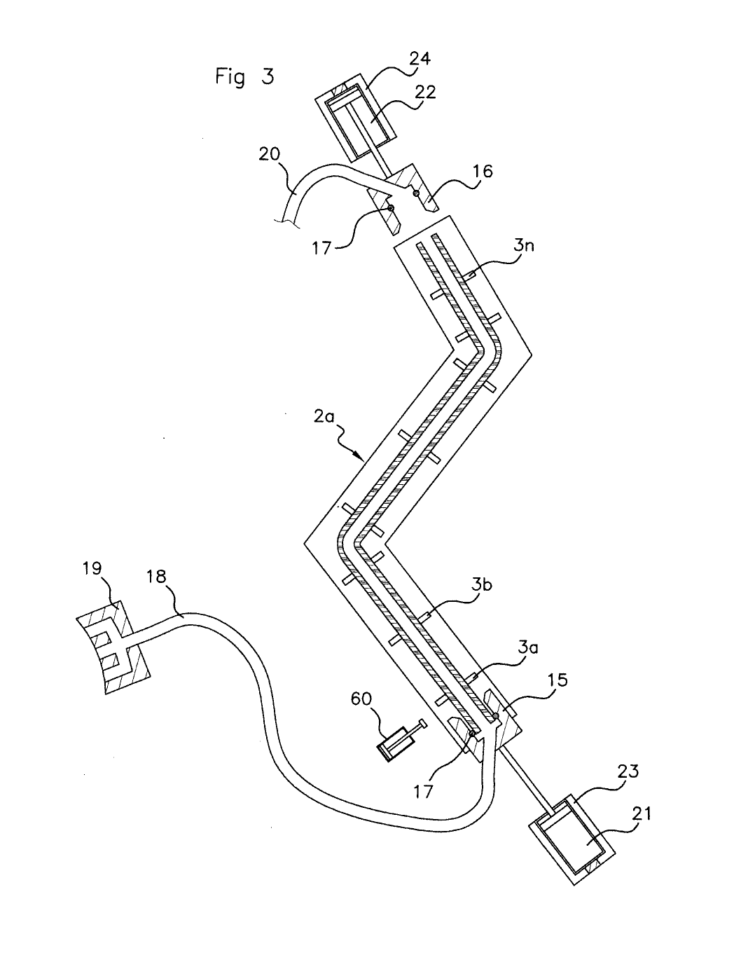

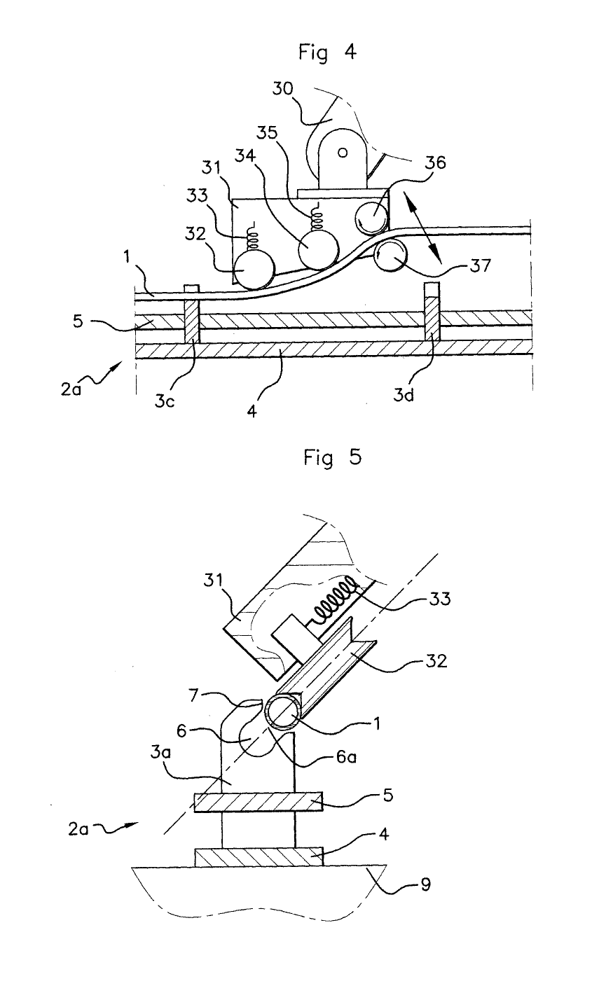

In the first place, the bending device shown in FIGS. 1 to 5 comprises:
A shaping unit 8 provided with a circular support plate 9 mounted to rotate on a base 28 and divided into four circular sectors of 90° forming four work stations 11-14, and drive elements in rotation 48-50 of the circular plate 9 being composed of, in the example, a ring gear 48 on which the circular plate is mounted, and a pinion 49 that engages with the gearwheel and that is driven in rotation by a motor 50 that is integral with the base 28,
For each bent tube model 1, four identical shaping templates 2a-2d, each forming an open guide pipe having the longitudinal profile of the bent tube and designed to be fixed in a removable way, each on one of the work stations 11-14, by way of a device for fixing and indexing their position,
A first robotized system 28, 29 designed for the charging of the tubes 1,
A plastic tube supply device 38-42 for supplying the first robotized system 28, 29 with plastic tube segments precut to a predetermined length,
And a second robotized system 43, 44 designed for mounting components on the ends of the bent tubes 1 and for the discharging of the bent tubes.

First of all, the shaping templates 2a-2d comprise, on the one hand, a base composed of two identical flat plates consisting of a lower base plate 4 and an intermediate base plate 5, and, on the other hand, specific guide elements 3a-3n that are suitable for delimiting the guide pipe.

First of all, the guide elements 3a-3n comprise a channel 6 with a diameter that is appreciably larger than the diameter of the tube 1, suitable for forming a pipe that is formed by a series of specific supports of the tube. These guide elements 3a-3n are adapted to a scale of specific guide elements provided with channels having planes of symmetry whose inclination in relation to the planes of the base plates 4, 5 varies over a range of values of between 0° and 90°.

By way of example, FIG. 5 shows a guide element 3a provided with a channel 6 whose plane of symmetry is inclined by an angle of 45° in relation to the plane of the base plates 4, 5.

In addition, each channel 6 comprises an opening 6a for inserting and removing the tube 1 having a width that is appreciably smaller than the diameter of the channel, suitable for imparting a retentive nature to the latter. This opening 6a for inserting and removing the tube 1 is also provided with beveled longitudinal edges 7, designed in particular to facilitate inserting the tubes 1 into the channels 6.

Regardless of the orientation of the channel 6, each of these elements 3a-3n comprises:
A smaller anchoring portion in the lower base plate 4, also having suitable dimensions for forming a crosspiece defining the distance separating the two base plates 4, 5,
And an upper guide portion in which the channel 6 is made.

Each base plate 4, 5 has the general shape of a rigid plate strip whose flat faces are centered on an axis coinciding with the longitudinal axis of the guide pipe formed by the channels 6 of the guide elements 3a-3n.

These two base plates 4, 5 are also pierced by transverse slots:
Designed to house the anchoring portion of the guide elements 3a-3n pertaining to the lower base plate 4,
Through which extend the upper portions of the guide elements 3a-3n pertaining to the intermediate base plate 5.

As mentioned above, the shaping unit 8 comprises four identical work stations 11-14, each suitable for accommodating a shaping template 2a-2d.

Each of these work stations 11-14 is also equipped with two connectors 15, 16 that incorporate a seal 17 and with each being suitable for being connected in an airtight way to one of the ends of the tube 1 inserted into the guide pipe 3a-3n of the shaping template 2a-2d.

One of these so-called supply connectors 15 is mounted on a feed pipe 18 connected to a suitable distribution valve 19, for example by means of a rotary joint, for making it possible to supply this feed pipe 18:
For the purpose of bringing the tube 1 to a temperature bringing about a brittle-ductile transition, with a centralized water vapor production source 25,
For the purpose of cooling the tube 1, in succession with a centralized cold-water production source 26, and then with a centralized air production source 27 for drying the tube after the latter is cooled.

The second connector 16 is mounted on a pipe 20 for draining fluid downstream from the tube 1.

Each of the connectors 15, 16 is also mounted on the rod of a cylinder 21, 22 whose body is made integral on a bracket 23, 24 whose base is suitable for being made integral on the support plate 9 in the extension of one of the ends of the shaping template 2a-2d in such a way as to make it possible to move each connector 15, 16 between a position for airtight connection to the tube 1 that is inserted into the shaping template and a position that is disconnected and distant from the tube.

The first robotized system is composed of a six-axis robot 28 combined with a programmable guidance unit 29 and comprising an arm 30 on the end of which is articulated a hand 31 for gripping tubes 1 and for inserting the latter into the guide pipe 3a-3n of the shaping template 2a-2d fixed on the work station 11-14 positioned opposite the robotized system.

The hand 31 for gripping and inserting this robot 28 comprises, first of all, a first press element 32 that has a bearing surface that can apply on the tube 1 a force of inserting the latter into the guide pipe 3a-3n of the shaping template 2a-2d. This press element is composed of, in the example, a wheel 32 provided with a peripheral channel with a cross-section mated to that of the tube 1, whose rotating shaft is acted upon by a suitable elastic device 33 for allowing the press element to travel in a direction that is parallel to the axis of the insertion force applied by the latter.

This hand 31 for gripping and inserting also comprises two motorized rollers 36, 37, placed and driven in rotation in such a way that the tube 1 engages between the rollers and is entrained toward the press element 32 in a travel direction opposite to the displacement direction of the gripping and inserting hand.

In addition, these motorized rollers 36, 37 are mounted on the gripping and inserting hand 31 by way of a device ensuring relative displacement of the rollers between a close driving position of the tube 1 and a separated escapement position of the tube.

Finally, the gripping and inserting hand 31 comprises a second press element 34 also composed of a wheel whose rotating shaft is acted upon by an elastic device 35. This second press element 34 is positioned:
Longitudinally, between the first press element 32 and the motorized rollers 36, 37,
In such a way that its bearing surface on the tube 1 extends into an intermediate plane between the plane of the bearing surface of the first press element 32 and the junction plane of the two motorized rollers 36, 37.

According to the invention, and as is shown in particular in FIG. 5, this first robotized system 28, 29 is also programmed for varying the inclination of the gripping and inserting hand 31 that is articulated in such a way that the insertion force of the tube 1 into the channel 6 of the guide elements 3a-3n is applied in an optimal way along an axis that is parallel to the plane of symmetry of the channel.

Furthermore, so as to prevent a possible longitudinal sliding of the tube inside the guide pipe 3a-3n, a retractable element, such as a cylinder 60, is suitable for locking the end of the tube in the guide pipe during the insertion of this tube into a shaping template 2a-2d.

The first robotized system 28, 29 is also combined with an automated plastic tube supply device that is suitable for supplying the gripping and inserting hand 31 with plastic tube segments precut to a predetermined length.

According to the example shown, these plastic tube supply device comprise:
A packaging coil 38 of the plastic tubing,
A mechanism for unwinding the coil 38, composed of motorized rollers such as 39, 40, between which the tube 1 travels and by which it is entrained,
A sensor 41, such as a coder, for measuring the length of the unwound tube,
And a cutting device 42 for cutting tube segments of preselected lengths.

The second robotized system is placed in such a way as to be positioned opposite one of the work stations 11-14 close to the work station positioned opposite the first robotized system 28, 29.

This second robotized system is composed of a six-axis robot 43 combined with a programmable guidance unit 44 and comprising an arm 45 on the end of which is articulated a hand 46 provided with elements 47 for gripping the bent tube 1 inserted into the guide pipe 3a-3n for the purpose of discharging this tube.

In addition, the robot 43 can also comprise a second hand (not shown) that is equipped and programmed in such a way as to make possible the mounting of components on the ends of the bent tubes 1.

After an initial manual stage of fixing shaping templates 2a-2d and supports 23, 24 of connectors 15, 16 on each of the work stations 11-14 and of indexing the position of the shaping templates 2a-2d, the shaping cycles comprise, for each of the work stations 11-14, the following stages, between each of which the work station is moved in rotation on a course of 90°:
Insertion of the tube to be bent that is held in the gripping and inserting hand 31 of the first robotized system 28, 29 in the guide pipe 3a-3n of the shaping template equipping the work station, and then connecting connectors 15, 16 with the tube 1 by deployment of the cylinders 21, 22,
Circulation of the water vapor intended for achieving the brittle-ductile transition,
Circulation in succession of cold water for cooling the tube, and then air for drying the tube,
Possible mounting of components on the ends of the bent tube 1, then disconnecting connectors 15, 16 by retraction of cylinders 21, 22, and discharging of the tube by means of the gripping hand 46 of the second robotized system 43, 44.

Apart from the initial positioning stage of the shaping templates 2a-2d and supports 23, 24 on the work stations 11-14, this bending device makes it possible to produce by thermoforming, at high speed, bent tubes 1 made of plastic material.

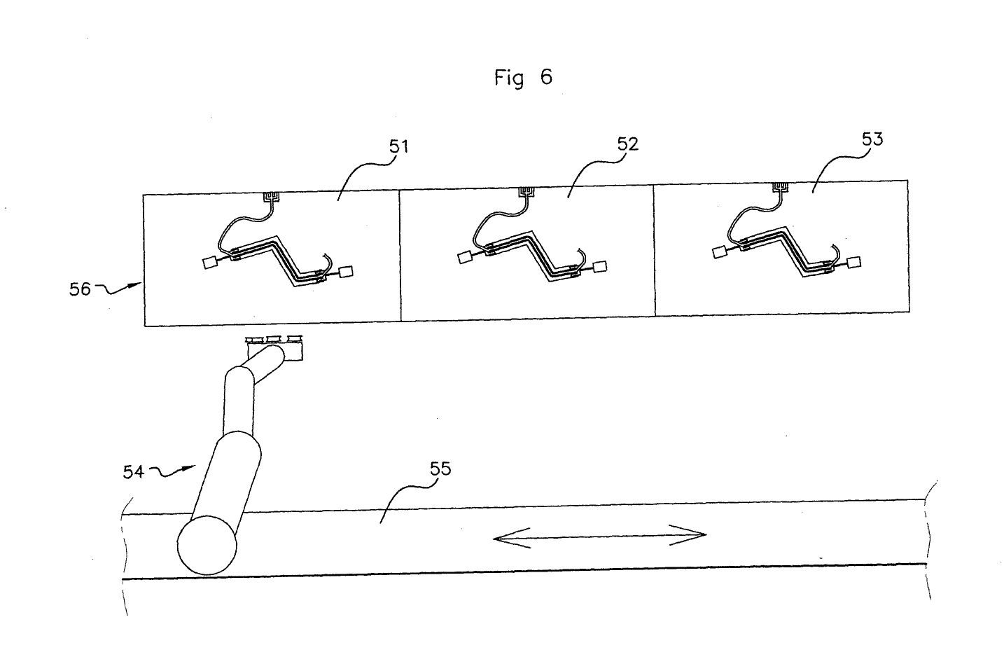

FIG. 6 shows, in a diagrammatic manner, a variant embodiment according to which:
The shaping unit 56 comprises three stationary work stations 51-53 aligned beside one another and comprising a piece of equipment that is similar to that of the work stations 11-14 described above,
The first robotized system 54 is suitable for being moved along a straight trajectory in such a way as to be positioned opposite each of the work stations 51-53 in succession, in such a way as to ensure the charging of a tube 1 in the guide pipe of the shaping template positioned on the work station, optionally preceded by the discharging of the tube bent in advance.

1-22. (canceled)

23. A bending device for the production by thermoforming of bent tubes made of plastic material, comprising:
a centralized heating-fluid supply for supplying a tube-heating fluid that is brought to a suitable temperature for achieving, by circulation of the tube-heating fluid inside tubes as they are bended, a brittle-ductile transition of the tubes,
a centralized cooling-fluid supply for supplying a tube-cooling fluid by circulation of the tube-cooling fluid inside tubes as they are bended,
a shaping unit comprising at least three work stations equipped with identical shaping templates, wherein each of the at least three work stations comprising:
a support plate provided with a device for fixing and indexing a position of the identical shaping templates,
a fluid circulation device forming a fluid circulation circuit, the fluid circulation device comprises:
a distribution element for connection to the centralized cooling-fluid supply making it possible to select a supply fluid of the fluid circulation circuit,
a feed pipe connected to the distribution element and provided with a free end that is equipped with a connector for airtight connection to the tube being bent,
a drain pipe provided with a free end equipped with a connector for airtight connection to the tube being bent,
a multi-articulated robotized system comprising a hand for gripping the tube to be bent, provided with a press element that has a bearing surface that can apply to the tube a force for inserting the latter into the identical shaping templates.

24. The bending device according to claim 23, wherein the centralized heating-fluid supply comprises a water vapor production source.

25. The bending device according to one of claim 24, wherein the centralized fluid supply of at least one cooling fluid comprises a cold-water production source and an air production source for drying tubes after the latter are cooled.

26. The bending device according to one of claim 23, further comprising an automated plastic tube supply for supplying the hand of the robotized system with plastic tube segments precut to a predetermined length.

27. The bending device according to claim 26, wherein the automated plastic tube supply comprises:
a packaging coil of the plastic tubing,
a mechanism for unwinding the packaging coil,
a sensor for measuring a length of an unwound tube,
a cutter for cutting the plastic tube segments to preselected lengths.

28. The bending device according to claim 23, wherein a displacement element of each connector consists of a cylinder with a rod on which the connector is made integral, and a body fixed on the support.

29. The bending device according to claim 23, wherein each of the identical shaping templates is provided with a guide consisting of specific guide elements comprising a channel with a cross-section mated to that of the tube, forming a guide pipe formed by a series of specific supports of the tube.

30. The bending device according to claim 29, wherein each of the specific guide elements comprises a retentive-shaped channel having an opening for inserting and removing the tube provided with beveled longitudinal edges.

31. The bending device according to one of claim 29, wherein the robotized system has a hand that is articulated in such a way as to be able to be programmed so that a force for inserting the tube into a channel of each of the specific guide elements is applied along an axis parallel to the plane of symmetry of the channel.

32. The bending device according to claim 23, wherein each press element consists of a wheel that is provided with a peripheral channel with a cross-section mated to that of the tube.

33. The bending device according to claim 32, wherein the each press element is combined with a suitable elastic for allowing the press element to travel in a direction that is parallel to the axis of an insertion force applied by the latter.

34. The bending device according to claim 23, wherein the bending device further comprises a retractable element for locking an end of the tube in the guide pipe of the identical shaping templates to be actuated during the insertion of a tube into the identical shaping templates.

35. The bending device according to claim 23, wherein the gripping hand of the robotized system comprises motorized rollers that are placed and driven in rotation in such a way that the tube engages between the rollers and is entrained toward the press element in a travel direction opposite to the displacement direction of the gripping hand.

36. The bending device according to claim 35, wherein motorized rollers are mounted on the gripping hand by a device ensuring relative displacement of the motorized rollers between a close driving position of the tube and a separated escapement position of the tube.

37. The bending device according to claim 23, wherein the shaping unit comprises stationary work stations with a relative displacement device of the robotized system and the shaping unit being suitable for displacing the robotized system in such a way as to bring it opposite each of the stationary work stations in succession.

38. The bending device according to claim 37, wherein the stationary work stations are aligned one after another, with a displacement device of the robotized system being adapted to displace the latter along a straight trajectory.

39. The bending device according to claim 23, wherein the shaping unit comprises suitable displacement of the stationary work stations for bringing the latter opposite a stationary position in which the robotized system is located in succession.

40. The bending device according to claim 39, wherein the shaping unit comprises a circular table that is divided into circular sectors, each circular table constituting a work station with a displacement of the work stations consisting of driving the circular table in rotation.

41. The bending device according to claim 40, wherein the shaping unit, driving the circular table in rotation and the centralized cooling-fluid supply are suitable for defining a cooling position of the work stations, in which two cooling fluids are delivered into the circulation circuit in succession.

42. The bending device according to claim 40, wherein the shaping unit and driving the circular table in rotation are suitable for defining a so-called charging/discharging position of the work stations with the robotized system comprising a second hand for gripping the bent tubes for the purpose of their discharging.
